(19) United States
(12) Patent Application Publication
(10) Pub. No.: US 2010/0282687 A1
(43) Pub. Date: Nov. 11, 2010

(54) System and Method for Extraction of Petroleum from Oil/Water Mixture

(76) Inventor: Charles ABRAHAM, Magnolia, TX (US)

Correspondence Address: KAMMER BROWNING PLLC, 7700 BROADWAY, SUITE 202, SAN ANTONIO, TX, 78209, US

(21) Appl. No.: 12/464,087

(22) Filed: May 11, 2009

(51) Int. Cl. C02F 1/26

(52) U.S. Cl. 210/744; 210/747

(57) ABSTRACT

A petroleum from oil/water mixtures extraction method for use as an adjunct to current stationary active second containment methods for industrial oil spill accidents, and as an adjunct to currently used equipment for residual oil removal in clean-out measures for, among others: canal barges, hazmat trucks, oil storage tanks, oil tankers, oil transportation railroad cars, river barges, as an on-board separation system for petroleum based bilge, and in coastal and inland waterways clean-up from oil spill accidents.

### CROSS REFERENCE TO RELATED APPLICATIONS

This application claims the benefit under Title 35 United States Code §119(e) of U.S. Provisional Patent Application Ser. No. 61/______; filed May, ______, 2008; the full disclosure of which is incorporated herein by reference.

### BACKGROUND OF THE INVENTION

1. Field of the Invention

The present invention relates generally to a method of extracting petroleum from an oil/water mixture through the removal and clean-up of an oil spill in point sources such as a lake or river. The present invention relates more specifically to utilizing a conveyor belt method to extract the oil/water mixture, funneling it into large extraction receptacles from whence the oil and water are separated through the principle of fluid dynamic application of Stoke's Law in which the difference in density/specific gravity of the two substances causes the petroleum to rise to the top of the receptacle and separate from the residual water.

2. Description of the Related Art

There are many methods and techniques for cleaning up oil spills in large open bodies of water using massive equipment and expansive means for which to cover greater areas of mass at one time. Technology for these inventions is centered on using vast collection means such as large sea nets or even an entire self-contained barge system to remove the oil by large scale recapture/destroy boom and skimmer systems and is extremely expensive. Yet, while these systems are effective for bulk oil spills with an unrestrained quantity of area and within which to operate and an unrestrained budget, these designs would be overwhelmingly inappropriate for use in spill clean-ups in close, shallow waters such as coastal and inland waterways, rivers, and canals. The difference in scale and restrictions on maneuverability are such as to warrant an entirely different means and method of clean-up.

The limited technology used in this area consists of such inventions as an oil entrapment watercraft that utilizes two pontoons to support a tower that is partially submerged in the water into which oil is pumped. Yet a model such as this cannot be used in shallow waters with the depth necessary to support the floating watercraft and is also limited in maneuverability in confined areas. An additional invention used for shallow waters is described as a skimmer boat identified as a hovercraft which uses a floating oil-collecting barrier affixed in a horseshoe shape around the rear and sides of the craft that channels the spill into a collection area at the rear of the craft for extraction through pumping means. This hovercraft utilizes a fan to push or direct the oil spill to the rear of the craft where it is extracted and stored in an onboard tank inside which the oil and water are separated and the oil is stored for future use. While this invention purports to contain and clean the spill, it still raises questions as to the simplicity of only using one centralized storage tank for which to separate and segregate the two and whether the water is sufficiently cleaned to proper standards prior to its reinsertion into the water source. Additionally, the use of a pumping system creates concerns of clogging and related issues when the hose is deployed underneath the water surface. Particularly in shallow waters, an overabundance of liquid and solid substances collect near the surface of the water causing murkiness and congestion that could lead to blockage of the pump or hose.

There have also been other additional methods for extracting an oil-based substance rather than using the pumping method such as a rope-guided pulley system in which a rope made of adsorbent material is positioned in a continuous loop around pulleys, which in turn one pulley is then lowered into the oil spill or like substance and guides the rope by mechanical or motorized force in a loop through the spill adsorbing the oil-based substance for removal. Ropes have also been used by mounting them on a boom of some sort and merely extending them out linearly behind a boat in a perpendicular fashion and dragged through an oil spill so as to adsorb the substance. Consequently, this method is somewhat ineffective in working within the confined work area of an inland waterway or river. Another method used includes a belt pumping device driven between two drums so as to create the same continuous loop as that of the rope and pulley system which adsorbs the oil-based substance and deposits it into a collection pan for future disposal. Yet, what these inventions lack in their application is the complete integration of both method and hardware to conform to the environmental surroundings and facilitate not only the extraction of the oil from the affected area but the preservation of that petroleum for future use and, more importantly, the reintegration of the affected (and subsequently cleaned) water safely back into its source so as to harm the environment in the least way possible.

It would be desirable, therefore, to have a device and method specifically designed to function within a confined area affected by a spill of some sort that is economically feasible and which utilizes the most effective means of cleaning the spill, separating the oil and water completely, preserving the petroleum for future use, and insuring that the cleaned water met water quality standards set forth by the U.S. Environmental Protection Agency Office of Water prior to depositing it back into the water source. These means could include a compact vessel capable of navigating inland waterways and rivers which encompasses the use of a pulley system or conveyor belt setup—so as to avoid the clogging problems associated with pumps—and deposits said oil/water mix into a thorough, efficient system containing a plurality of separation and filtering containers utilized to insure complete separation and segregation of the two substances.

Traditional Ocean Oil Spill Removal Organization models center their technology and operations on deep waters of the open sea (marine waters) in large scale recapture/destroy boom and skimmer systems. These are overwhelmingly inappropriate for the uses claimed for this invention, e.g. in close shallow water work requisite to coastal and inland waterways oil spill accident cleanup where delicate riverine and/or estuarine ecosystems are at risk. Traditional Ocean Oil Spill Removal Organizations (OSROs) are ill-equipped, inexperienced, and/or inadequately trained in responding to oil spill accidents impacting cultural and environmental freshwater and/or saline estuary waterways caused by the following and other potential sources: bulk storage tanks located next to canals, rivers: and other inland waterways; canal barge routes; Hazmat truck routes; highways having petroleum truck routes; onshore oil processing facilities; petroleum pipelines; railroad crossings; river barge routes. Existing methods of oil spill accident petroleum evaporation trigger loss of lighter material rendering petroleum hydrocarbons denser than water, so that it sinks to the bottom of canals, lakes, and rivers where it sedimentizes into tar mats and tar logs, enormously complicating the recapture/destruction of the petroleum. Dispersion of an oil spill with chemical agents that emulsify, disperse, or solubilize petroleum hydrocarbons into the water column or that promote surface spreading of oil slicks to facilitate dispersal of oil into the water column severely challenges sensitive wetlands and freshwater ecosystems. Aerobic and/or anaerobic biodegradation and/or bioremediation of an oil spill accident risks disturbance and even irreparable and irretrievable disequilibrium of coastal and inland ecosystems through introduction of non-indigenous biota (biological agents.) (CF. Bernard Matthew, et al. “Endangered Species and the Use of a Biological Opinion During Spill Responses” The U.S. Environmental Protection Agency Office of Emergency Management 2006 Freshwater Spills Symposium.) On the other hand, biodegradation of land-based and crude-oil gasoline contaminated soils may be an effective and cost efficient Removal Response Option, if the soils can be reworked. In situ burning of oil slicks and spills unleashes an immediate release of hydrocarbon pollutants into the atmosphere and presents still poorly understood and inadequately researched longitudinal effects for adjacent ecosystems and population centers. Additionally, in situ burning is impracticable where there is strong tidal movement and other hydrological and geological characteristics in or near saline estuarine waters. Coastal and inland oil spill burn off thereby poses potential non-compliance with the National Pollutant Discharge Elimination System regulatory program and State Water Quality Standards, since existing in-stream water uses may be significantly altered.

### SUMMARY OF THE INVENTION

It is the object of the present invention to provide a novel method for extraction of petroleum and other oils from an oil/water mixture. The invention comprises an absorbent belt skimming, on-board oil/water separator applying the hydrodynamic principle that oil, lighter than water, will not only float to the surface of a total oil/water mixture flow, but will force the water down and out a bottomless Extraction Receptacle housed within an Exterior Container. It is another object of the present invention to drain the separated water into a second bottom-less Extraction Receptacle housed within a second Exterior Container, for a repeat process.

It is another object of the present invention to drain the water from the second surrounding Exterior Container into a third collection vat for organoleptic and/or appropriate, cognate testing for levels of water quality acceptably free of petroleum hydrocarbons before discharge back to point source, in compliance with The Spill Prevention Control and Countermeasure Rule.

It is another object of the present invention to drain the extracted petroleum for re-sale or re-use from both the first and second Extraction Receptacles into on-board oil drums or into VOSS Bladders.

It is another object of the present invention to provide a lid for both the first and the second Extraction Receptacles in order to diminish intake of sunlight and air to the extracted petroleum to inhibit bacterial growth, should pre-drain-off storage be required for an extended length of time.

It is another object of the present invention to provide an easily adapted application, mounted on wheels as a trailer and with an appropriately extended endless absorbent belt skimmer, as an adjunct to current stationary active second containment methods.

It is an another object of the present invention to provide an easily adapted application with an appropriately extended absorbent belt skimmer as an adjunct to currently used equipment for residual oil removal in clean-out measures for, among others: canal barges, Hazmat trucks, oil storage tanks, oil tankers, oil transportation railroad cars, river barges.

It is an another object of the present invention to provide an effective and cost efficient method mounted on a gyroscope maintaining equilibrium in storm conditions for extracting petroleum from bilge permitting re-use of the residual water as on-board grey water and recycling of the petroleum.

It is an another object of the present invention to provide a 5″-18″ shallow draft advancing mono-hull or pontoon vessel with the invention mounted on it for use in coastal and inland waterways oil spill cleanup.

In satisfaction of these and related objectives, unlike Ocean Oil Spill Response methodologies, the present invention provides a novel easy access (trailerable) Saline and Freshwater Oil Spill Response Technology for the uses cited supra, e.g. in holistic coastal and water-shed based strategies with the distinct advantages of on-board oil/water mixture separation and extraction of petroleum for re-sale or re-use with no insult to the ambient ecosystem.

The present invention provides a method for extracting petroleum and other oils from an oil/water mixture, most notably from a mixture removed from a water source contaminated by a spill of oil or similar substance. This invention includes an encompassing system to remove the mixture from the affected source, transport the mixture into a collection of two extraction receptacles and a water collection vat connected in series through which the mixture is passed to separate the petroleum from the liquid wherein the water continues through the three receptacles to ensure it is completely decontaminated and safe to return to its source. The separated petroleum is collected in the receptacles once the water is filtered out and is then pumped into collection drums or a storage bladder for future use. It is the object of the present invention to provide a method that includes the most efficient methods available to address an oil spill within a constricted environment such as an inland waterway or causeway and to separate said liquids for future use.

The mechanism of the present invention to extract the oil/water mixture from the affected source consists of an absorbent conveyor belt mounted on a boat or small vessel that is lowered into the water merely to skim the surface and extract the oil/water mixture. The belt is lined with an adsorbent, oleophylic material sewn in a continuous loop so as to attract the oil and extract it from the water by means of a motorized pulley system to drive the belt. The oil/water mixture is taken up the conveyor where it meets a pinch roller and funnel where the oleophylic belt is squeezed by the pinch roller so as to release the mixture and funnel it into the first of the two extraction receptacles. These cubed receptacles are bottomless, yet enclosed within an exterior container designed to be just inches wider than the receptacle. Here, through the principle of fluid dynamics and Stoke's law, the two substances separate based on the difference in their density and specific gravity which causes the petroleum to rise to the top. Wherein, the petroleum's weight pushes the water down through the bottomless receptacle and up into the void created between the walls of the receptacle and exterior container, leaving only the petroleum in the receptacle. The water is then push out through exit pipes connecting the first container to the second receptacle in series where the separation process commences again for whatever oil/petroleum mixture did not separate in the first receptacle. The water is then pushed again through the exit pipes of the outer container into a third collection vat for organoleptic and/or appropriate, cognate testing for levels of water quality acceptably free of petroleum hydrocarbons. This testing is implemented to insure the water is clean and in compliance with the Spill Prevention Control and Countermeasure Rule set forth by the U.S. Environmental Protection Agency Office prior to its discharged from the vat back into its point source allowing no insult or disturbance to the ambient ecosystem. The petroleum is collected within the receptacles and can then be pumped into on-board oil drums or later into VOSS bladders or other storage tanks for future use.

The mechanism for which this system is mounted could include such vessels as a mono-hull or pontoon boat or craft able to be navigated in coastal and inland waterways. This craft includes retractable arms mounted on each side of the hull that are deployed outward either manually or mechanically in order to create a collection barrier with which to amass the spillage into one area for more efficient removal. This vessel could incorporate the extraction system into the hull by housing the receptacles and storage drums below its deck, allowing for the extracted mixture to be funneled from the skimming belt down through openings in the deck revealing the receptacles. However, another embodiment of the vessel could eradicate the deck completely and create walkways along the insides of the hull next to the receptacles. This boat or craft is able to be transported from location to location on a trailer for fast, efficient use in numerous locations.

Inescapably, it is imperative to research and develop a Spilled Oil Recovery System (SORS) which confronts and offers feasible solutions to the above-outlined problems, since both the United States Environmental Protection Agency and the United States Department of Pipeline and Hazardous Materials Safety Administration require a classified Oil Spill Removal Organization under contract and listed in Facility Response Plans (FRP) to address oil spill accidents.

The present invention maximizes effective and cost efficient oil spill cleanup under specific conditions frequently difficult or impracticable for traditional Ocean Oil Spill measures including: access to adequate equipment; access to trained personnel; all water temperatures, though extremely cold water can densify the oil and lead to sinking; all but Bunker ClGrade V Oil film thickness; calm coastal zones and seas and freshwater; high pour point; high viscosity; lighter gasolines and fuel oils due to high evaporation rates; near inter-tidal zones; shallow waters adjacent to shore lines; Small window of opportunity; Spills too close to corral reefs or fisheries, and weathered oil.

Current State-of-the-Art puts focus on oil detection, recovery, and destruction, entailing considerable financial loss to oil owners who must shoulder the cost of clean-up, as well as. bear staggering insurance costs. A paramount advantage of the present invention resides in the fact that petroleum is extracted from the oil spill site and immediately separated on board for storage and re-use or re-sale with negligible costs of recycling. Critical Issues resolved by the present invention for western U.S. companies in need of Oil Spill Response Organizations (OSROs) include: existing OSROs are largely outside Connection Oriented Transport Protocol circles; OSROs response time frames are excessively long; the present invention, optionally mounted on wheels with an appropriately lengthened conveyor belt, provides an efficient and cost effective adjunct to active secondary containment measures, such as barriers, berms, culverting, curbing, drainage systems, dykes, gutters, retaining walls, retention ponds, spill diversion ponds, sumps, and weirs.

The present invention meaningfully augments the nation's oil spill protection resources, as called for at the United States Environmental Protection Agency Office of Emergency Management 2006 freshwater spills symposium (Portland, Oreg.) by Dee Bradley in her presentation Inland Wafer Oil Spill Removal Organizations (OSROs): The Need for Inland Environment OSROs in the Western United States: “Possible Ways to Create More Inland OSROs . . . Encourage Existing Contractors to Invest in Spill Response Equipment and Training . . . ”

### BRIEF DESCRIPTION OF THE DRAWINGS

For a fuller understanding of the nature and objects of the invention, reference should be had to the following detailed description taken in conjunction with the accompanying drawings in which:

FIG. 1 is a cross sectional view of the present invention, the petroleum extraction receptacle housed within an exterior container.

FIG. 2 is an end plan view (with helm components removed for clarity) of the attachment system connecting the petroleum extraction receptacle to the exterior container (the invention).

FIG. 3 is a partially schematic side view of the system of the present invention showing the various tanks and conduits connecting the system.

FIG. 4 is a partially schematic top plan view of the present invention mounted on a mono-hull or pontoon vessel.

FIG. 5 is a side cut away view of a typical pinch roller structure operable in conjunction with the system of the present invention.

FIG. 6A-6C are orthogonal views of a typical pontoon platform operable in association with the system of the present invention.

FIG. 7A-7D are orthogonal views of a typical ramp operable in association with the system of the present invention.

### DETAILED DESCRIPTION OF THE PREFERRED EMBODIMENTS

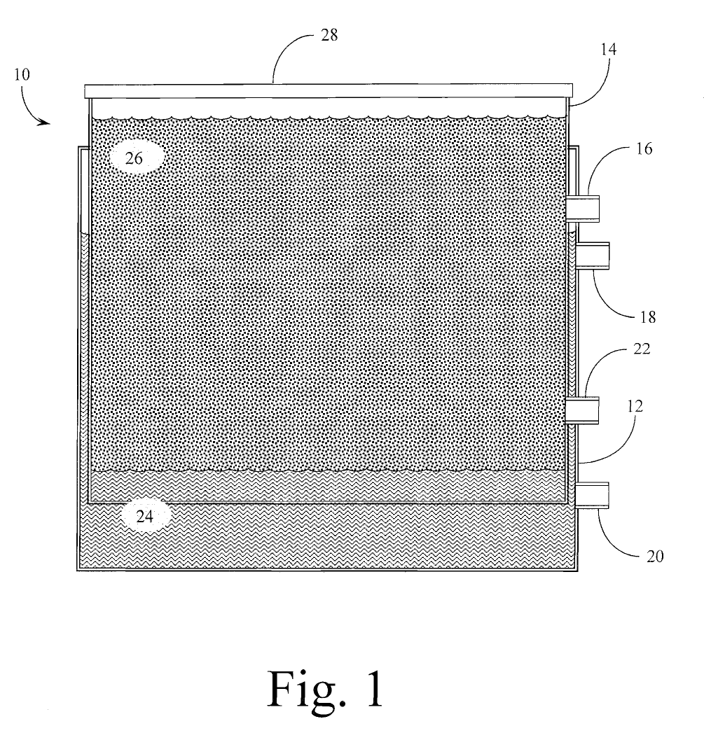

FIG. 1 is a cross sectional view cut away of the invention, the petroleum Extraction Receptacle housed within an Exterior Container. Claimed invention 10, the form for the petroleum Extraction Receptacle 14 housed within an Exterior Container 12. Wall of Exterior Container 12 (the invention). Wall of petroleum Extraction Receptacle (the invention) 14. The petroleum exit 16 from the invention, the petroleum Extraction Receptacle through wall of same and attaching to an external faucet and pipe for drainage into an oil drum or VOSS (floating bladder.) Residual water-exit faucet and pipe 18 for drainage into a second petroleum Extraction Receptacle (the invention). Residual water drain 20 for cleaning the Exterior Container. Residual petroleum drain 22 through both walls for cleaning the petroleum Extraction Receptacle. Residual water 24 forced out the bottom-less Extraction Receptacle 14 by the petroleum extracted. Extracted petroleum 26 within the Extraction Receptacle 14. Lid 28 on petroleum Extraction Receptacle (the invention) to inhibit bacterial growth by excluding sunlight and air.

Note: As the oil/water mixture is emptied into the invention, the petroleum Extraction Receptacle, the petroleum floats on the water and forces it out the bottomless floor and up the inside wall of the Exterior Container (the invention). The residual water is fed into the second petroleum Extraction Receptacle (the invention) for a repeat process. The extracted petroleum is drained out into oil drums or VOSS (floating ladders.) After the repeat process, the residual water is tested in a collection vat for EPA Water Quality Standards and returned to point source.

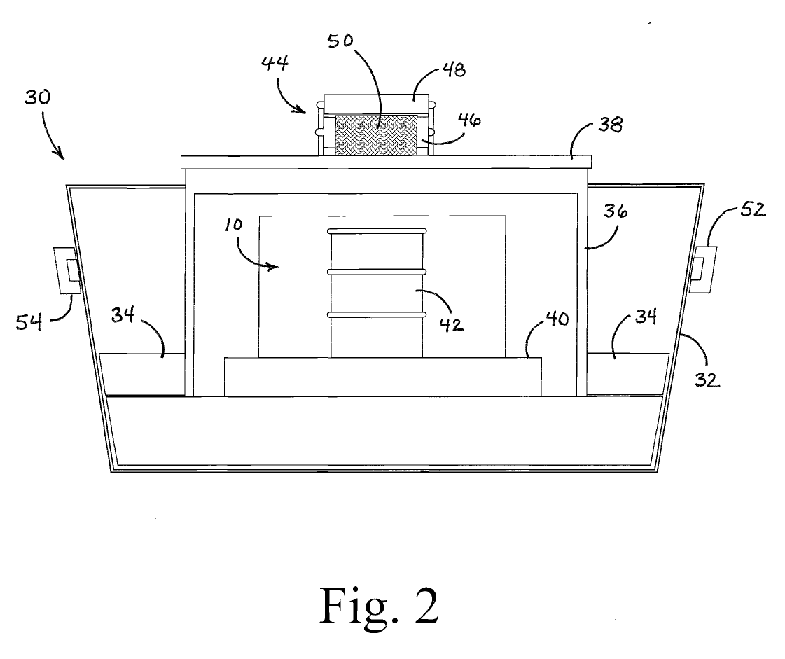

FIGS. 2 & 3 are plan views of the attachment system connecting the invention, the petroleum extraction Receptacle to an Exterior Container. Basic form of the wall of the petroleum Extraction Receptacle 10 housed within the Exterior Container (the invention). Walkway 34. Bottom of mono-hull or pontoon vessel 30. Wall 32 of mono-hull or pontoon vessel along which retractable arms 52 and 54 attached.

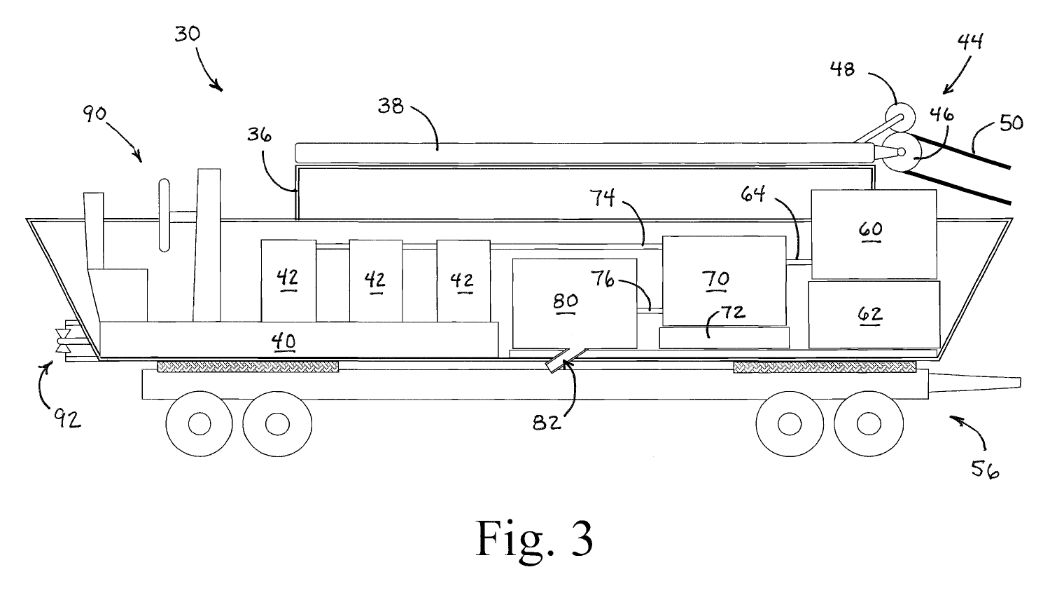

FIG. 3 shows a side view of the conveyor belt assembly 44 at an angle appropriate to all uses except tank clean-out. Trailer 56 on which is mounted the invention. Conveyor belt 50 with oleophylic material sewn into a continuous loop. Pinch roller 48 and funnel (not shown) emptying into the invention, the first petroleum Extraction Receptacle 60, Platform 38 upon which conveyor belt rests when withdrawn and not in use. First petroleum Extraction Receptacle 60 housed within an Exterior Container (the invention). Stand 62 upon which the first petroleum Extraction Receptacle housed within an Exterior Container (the invention) rests. Exit pipes 64 from first petroleum Extraction Receptacle housed within an Exterior Container (the invention). Second petroleum Extraction Receptacle 70 housed within an Exterior Container (the invention). Stand 72 upon which second petroleum Extraction Receptacle housed within an Exterior Container (the invention) rests. Final collection Container 80 (the invention) for collection of residual water, Exit pipe 82 returning residual water to point source. Stand 40 upon which oil drums rest. Oil drums 42.

FIG. 3 also shows helm 90, conveyor belt 50, pinch roller 48 and belt roller 46. Oil/water mixture pinched into first petroleum Extraction Receptacle (the invention). First and second inventions. Water drain 64 to second Extraction Receptacle 12″ from top. Water drain 76 to final Collection Container 18″ from top. Note: Extracted petroleum is drained off the first and second Extraction Receptacles 12″ from the bottom of same so as to avoid collection of residual water with it. Final collection Container (the invention) for residual water testing and release. Exit pipe releasing residual water to point source. All tanks have bottom drains for cleaning Mono-hull or pontoons. Outboard motor 92 or airboat motor.

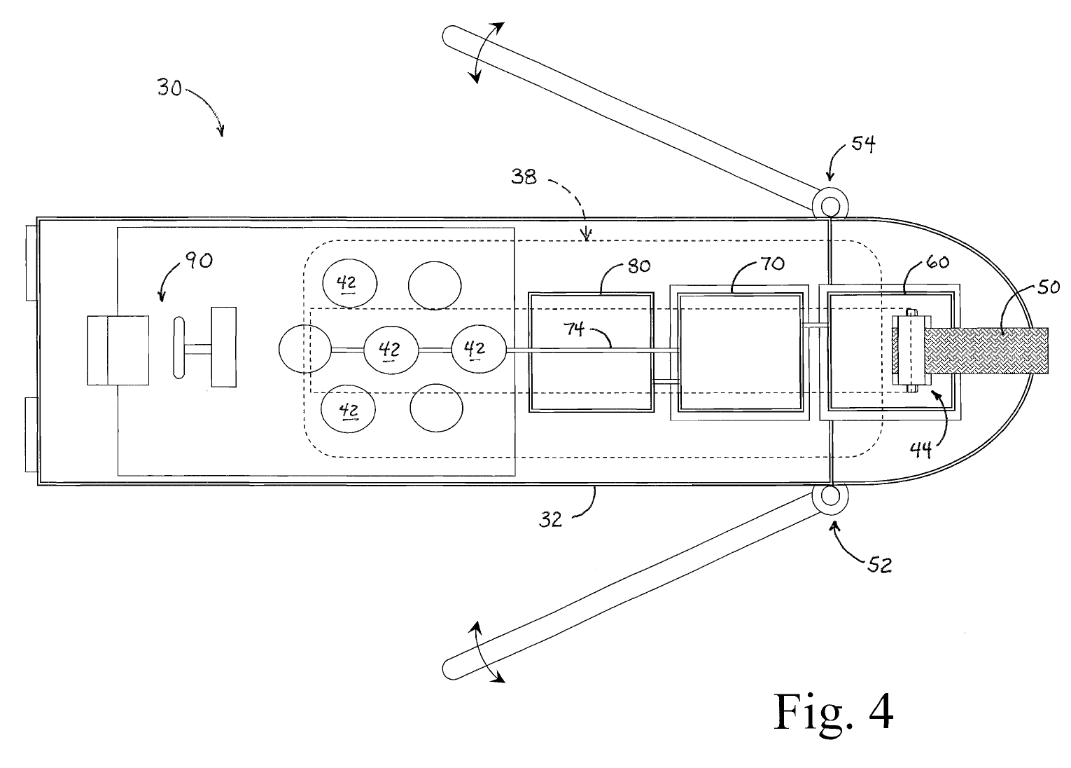

FIG. 4 is a top plan view cut away of the invention mounted on a mono-hull or pontoon vessel. First and second invention. Exit pipes for drainage from the invention. Walkway. Exit pipe for return of residual water to point source after testing. Steering wheel and mechanism. Helm. Retractable arms 52 and 54 for channeling oil/water mixture at pollution site into the conveyor belt 50. Outboard motors or airboat motors.

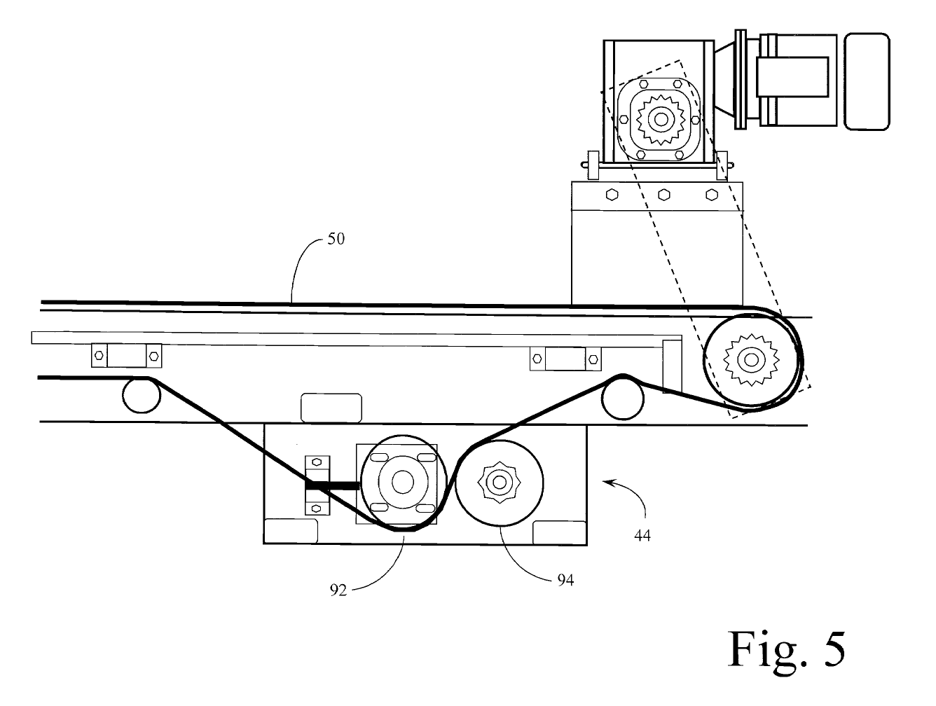

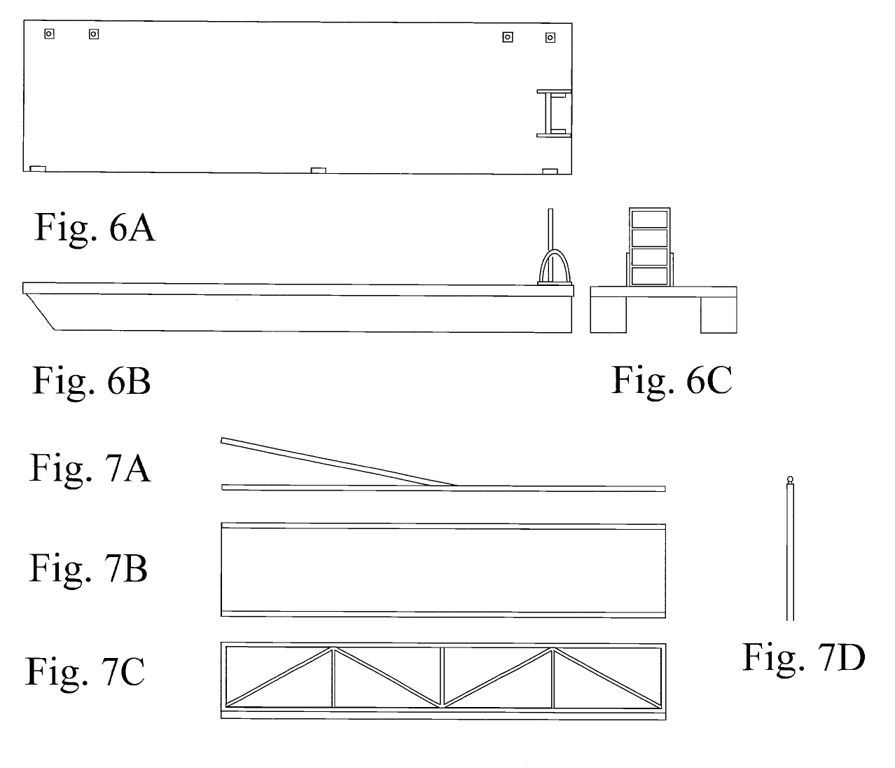

FIG. 5 shows vulcanized V-guided pinch roller 92. Pinch roller and bearings 94. In all claimed uses, the invention has an interior receptacle (Extraction Receptacle) for oil/water mixture collection and discharge into a surrounding exterior container (Exterior Container) of residual water meeting Water Quality Standards and the Anti-Degradation Policy (WQS) of the U.S. Environmental Protection Agency Office of Water. The Extraction Receptacle is bottomless for passage of residual water from the Extraction Receptacle out into an Exterior Container, whose lip is lower than the top of the Extraction Receptacle. From the lower side of the Exterior Container a faucet allows drainage of residual water into a pipe connecting with a second Extraction Receptacle for repeat of the process and collection of second-stage residual water from which a second-stage faucet and pipe allows drainage into a third-stage collection vat. Following quality standard testing the WQS water can then be discharged back to point source. From the Extraction Receptacle a discharge pipe passes through an Exterior Container to a second faucet allowing drainage of the collected petroleum into on-board oil drums or, in coastal and inland waterways oil spill clean-up operations, in Vessel of Opportunity Skimming System Temporary Storage Devices—floating storage bladders—(Voss Bladders.) The oil/water mixture is brought up from the oil spill accident and discharged into the first Extraction Receptacle housed within the first Exterior Container, both of which have previously been one-third filled with clean water to preclude passage of the oil/water mixture out the bottom-less first Extraction Receptacle and into the first Exterior Container. The oil/water mixture is brought up and discharged into the first Extraction Receptacle by means of an endless oleophilic absorbent belt skimmer comprising a conveyor belt having its exterior covered by hypalon, neoprene, nitrile, polyolefin, polyethylene, polypropylene, a combination of the above, e.g. polyolefin sewn onto the mat-finish side of neoprene, or other highly oleophilic material sewn into an endless, continuously moving loop. The oil/water mixture brought up on said oleophilic material by the skimmer is pinched by a pinch roller into the first Extraction Receptacle.

The embodiment of the invention is a novel fluid dynamics application of Stoke's Law (George Gabriel Stokes, 1851) in a gravity separation device based on the rise velocity of petroleum droplets corresponding to their density and size. The design of the invention functions by the specific gravity difference between the petroleum droplets and the water droplets in the oil/water mixture. In this novel application of Stoke's Law (1857), the extraction of the petroleum from the oil/water mixture occurs when the specific lighter gravity in the fluid viscosity of the petroleum droplets brings it to the surface of the oil/water mixture where it floats on the water droplets within the petroleum Extraction Receptacle. By its frictional force, it thereby forces the water droplets in their settling velocity out the open bottom of the Extraction Receptacle. The buoyant force, balancing the gravitational force, thereby permits collection of the water in the surrounding Exterior Container for drainage out a faucet and pipe. The extracted petroleum exits via gravity through a pipe leading through the Extraction Receptacle to a faucet and pipe in the wall of the Exterior Container whence it is drained to oil drums or into Vessel of Opportunity Skimming System Temporary Storage Devices—floating storage bladders—(VOSS Bladders).

In general therefore the present invention describes an on-board petroleum from oil/water mixtures extraction method that includes an interior receptacle container (Extraction Receptacle) for oil/water collection, extraction of the petroleum thereof, and a process whereby end-stage WQS water can be discharge back to point source, pursuant to Water Quality Standards of the Standards Branch, Criteria and Standards Division (WH-585), Office of Water Regulations and Standards, United States Environmental Protection Agency.

The system further includes an oleophilic absorbent belt skimmer, e.g. of polyolefin, sewn onto a conveyor belt, e.g. of neoprene, in an endless, continuously moving loop, which conveys the oil/water mixture up to a pinch roller pinching the oil/water mixture into a bottom-less Extraction Receptacle in communication with an Exterior Container whose lip is lower than the top of the Extraction Receptacle.

The system further includes a faucet and pipe fitted to said Extraction Receptacle for on-board discharge of the extracted petroleum into oil drums or: in coastal and inland waterways oil spill accident clean-up from a mono-hull or a pontoon vessel, into Vessel of Opportunity Skimming System Temporary Storage Devices—floating storage bladders—(VOSS Bladders.).

The system further includes a faucet and pipe fitted to the Exterior Container allowing discharge of the water out and into a second Extraction Receptacle within a second Exterior Container, whence the residual water can be drained into a third-stage water collection vat for WQS testing and end-stage discharge back to point source.

The petroleum extraction method of the system of the present invention functions according to Stoke's Law, the principle that petroleum, lighter than water, will float for collection to the surface of the Extraction Receptacle, and will thereby force the residual measurably cleaner water out the open bottom of the Extraction Receptacle and into the Exterior Container for collection and further second-stage processing before a third, end-stage testing and discharge back to point source. The extracted petroleum is drained into on-board oil drums or into VOSS Bladders. The petroleum extraction method of the present invention comprising a support means for supporting, for removal, and for after-use cleaning of said Extraction Receptacle, said support means attached to outer wall of the Extraction Receptacle and to the inner wall of said Exterior Container.

The petroleum extraction method further comprises control means for controlling said petroleum extraction method and influent discharge of oil/water mixture into the Extraction. The second Exterior Container for collection of WQS-tested water discharged out the faucet and pipe connecting the second Extraction Receptacle container with said first Exterior Container. The petroleum extraction process embodied in the first Extraction Receptacle housed within the first Exterior Container is repeated in the second Extraction Receptacle housed within the second Exterior Container with the residual water flowing through the faucet and pipe into a third-stage water collection vat comprising water quality analyzing means for detecting and testing levels of water quality before end-stage discharge back to point source, pursuant to the Clean Water Act and to Water Quality Standards of the U.S. Environmental Protection Agency Office of Water.

Although the present invention has been described in terms of the foregoing preferred embodiments, this description has been provided by way of explanation only, and is not intended to be construed as a limitation of the invention. Those skilled in the art will recognize modifications of the present invention that might accommodate specific environments or geographic conditions, or which might accommodate variations in hydrocarbon/water mixture environments. Such modifications as to structure, orientation geometry, and even materials, do not necessarily depart from the spirit and scope of the invention.

I claim:

1. An on-board petroleum from oil/water mixtures extraction method comprising:
an interior receptacle container (Extraction Receptacle) for oil/water collection, extraction of the petroleum thereof, and a process whereby end-stage WQS water can be discharge back to point source, pursuant to Water Quality Standards of the Standards Branch, Criteria and Standards Division (WH-585), Office of Water Regulations and Standards, United States Environmental Protection Agency;
an oleophilic absorbent belt skimmer, e.g. of poiyolefin, sewn onto a conveyor belt, e.g. of neoprene, in an endless, continuously moving loop, which conveys the oil/water mixture up to a pinch roller pinching the oil/water rn˜xture into a bottom-less Extraction Receptacle in communication with an Exterior Container whose lip is lower than the top of the Extraction Receptacle;
a faucet and pipe fitted to said Extraction Receptacle for on-board discharge of the extracted petroleum into oil drums or: in coastal and inland waterways oil spill accident clean-up from a mono-hull or a pontoon vessel, into Vessel of Opportunity Skimming System Temporary Storage Devices—floating storage bladders—(VOSS Bladders); and
a faucet and pipe fitted to the Exterior Container allowing discharge of the water out and into a second Extraction Receptacle within a second Exterior Container, whence the residual water can be drained into a third-stage water collection vat for WQS testing and end-stage discharge back to point source.

2. The petroleum extraction method of claim 1 functioning according to Stoke's Law, the principle that petroleum, lighter than water, will float for collection to the surface of the Extraction Receptacle, and will thereby force the residual measurably cleaner water out the open bottom of the Extraction Receptacle and into the Exterior Container for collection and further second-stage processing before a third, end-stage testing and discharge back to point source and the extracted petroleum is drained into on-board oil drums or into VOSS Bladders.

3. The petroleum extraction method of claim 1 further comprising a support means for supporting, for removal, and for after-use cleaning of said Extraction Receptacle, said support means attached to outer wall of the Extraction Receptacle and to the inner wall of said Exterior Container.

4. The petroleum extraction method of claim 1 further comprising control means for controlling said petroleum extraction method and influent discharge of oil/water mixture into the Extraction. The second Exterior Container for collection of WQS-tested water discharged out the faucet and pipe connecting the second Extraction Receptacle container with said first Exterior Container and the petroleum extraction process embodied in the first Extraction Receptacle housed within the first Exterior Container is repeated in the second Extraction Receptacle housed within the second Exterior Container with the residual water flowing through the faucet and pipe into a third-stage water collection vat comprising water quality analyzing means for detecting and testing levels of water quality before end-stage discharge back to point source, pursuant to the Clean Water Act and to Water Quality Standards of the U.S. Environmental Protection Agency Office of Water.
